(19) United States
(12) Patent Application Publication
(10) Pub. No.: US 2012/0082837 A1
(43) Pub. Date: Apr. 5, 2012

(54) High Water-Absorption and Anti-Bacterial Fibers

(75) Inventors: Jo-Wei Huang, Zhongli City (TW); Chun-Yi Li, Zhongli City (TW); Mei-Ting Fan Chiang, Zhongli City (TW)

(73) Assignee: FAR EASTERN NEW CENTURY CORPORATION, Taipei City (TW)

(21) Appl. No.: 13/051,218

(22) Filed: Mar. 18, 2011

(30) Foreign Application Priority Data
Oct. 4, 2010 (TW) 99133713

(51) Int. Cl. C08G 69/10

(52) U.S. Cl. 428/221; 528/328

(57) ABSTRACT

A polyglutamic acid (γ-PGA) fiber having antibacterial property and high water absorptivity is provided. A main component of the γ-PGA fiber includes a modified γ-PGA, and the modified γ-PGA is a polymer consisting of a γ-glutamic acid segment and a γ-modified glutamic acid segment, in which the modified glutamic acid segment has a formula as shown below:

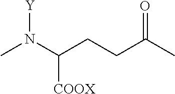

wherein X is H or Na, and Y is Cl, Br or I, and wherein a molar ratio of the modified γ-glutamic acid segment to the γ-glutamic acid segment is not lower than 0.05.

### RELATED APPLICATIONS

This application claims priority to Taiwan Application Serial Number 099133713, filed Oct. 4, 2010, which is herein incorporated by reference.

### BACKGROUND

1. Field of Invention

The present invention relates to a high water-absorption fiber. More particularly, the present invention relates to a γ-polyglutamic acid (γ-PGA) fiber having antibacterial property and high water absorptivity.

2. Description of Related Art

High water-absorption materials have water absorptivity, and can retain water of tens or hundreds folds of their own weight after absorption, thus having a quite wide application range. Conventionally high water-absorption materials can be mainly divided into two types. One is carbohydrate based, such as polysaccharides. The polysaccharides can be starch, chitosan, sodium alginate, and carboxymethyl cellulose (CMC), for example. These materials are natural materials, and have good biodegradability, but are limited in application due to limited water absorptivity (generally not higher than 10 folds). The other type is chemically synthesized polymers, such as polyacrylate or poly(vinyl alcohol). These materials have better water absorptivity than the above natural materials do. They also have some problems such as complicated preparation and potential release of toxic monomer and base residues. Furthermore, these chemically synthesized polymers are not biodegradable, and thus will cause hazard to environment after disposal. Therefore, in view of the environment protection requirement, the natural polysaccharide materials having poor water absorptivity are still generally selected to be used as the main water-absorption material.

Conventional high water-absorption materials are commonly prepared in a form of hydrogel or film. For example, Japanese Patent Publication No. 94-322358 discloses a method for cross-linking a γ-PGA solution by a γ-ray cross-linking technology to prepare a high water-absorption hydrogel. Furthermore, it is also mentioned in U.S. Pat. No. 4,572,906 that a water-absorption film dressing can be prepared from a mixture of chitosan and gelatin. However, the film and hydrogel disclosed in these technologies cannot provide a flow guiding function when they contact with a liquid. Because only the flat surfaces of the film and hydrogel can contact with the liquid, the overall is water absorption rate is low. Thus, it results in limited application.

However, if a water-absorption material is fiberized, the contact area may be efficiently increased, thereby increasing the water absorption rate. Moreover, the structure of the fiber may further provide the flow guiding function, so as to increase the water absorption rate. U.S. application Ser. No. 12/757,288 discloses that natural γ-PGA can be spun out in a partially cross-linked form, to prepare γ-PGA fibers having high water absorptivity. By this technology, the problem of the low water absorption rate of the conventional natural water-absorption materials is fully solved.

The γ-PGA fibers above have good biodegradability. Thus, if a part of the material decomposes while using, the whole structure of the fibers will be destroyed and disintegrated. Therefore, the water absorptivity is lowered. On the other hand, when a part of the material is decomposed, oligopeptides or amino acid monomers may be formed. However, because these substances are nutrient sources of microorganisms, these may cause growth of microorganisms. If such a fiber directly contacts with a human body or is prepared into a dressing material for health care, infection with the organisms may occur. In order to prevent the occurrence of such a hazard, sufficient antibacterial ability is required to introduce into this fiber.

In the prior art, an antibacterial treatment method of fibers is generally attaching an organic or an inorganic antibacterial material to fibers. The inorganic antibacterial material is generally a support containing metal ions (e.g., Ag⁺, and Zn²⁺), or metal nanoparticles (for example, silver nanoparticles). The inorganic antibacterial material above can release the metal ions or the metal nanoparticles above to bind cellular proteins of microorganisms to inactivate the is microorganisms, thereby to achieve the antibacterial efficacy. The antibacterial effect is generally relatively long acting. However, a process for attaching the inorganic antibacterial material on the fibers is complicated and highly cost (as known from U.S. Pat. Nos. 6,333,093, 6,451,003, and 6,267,782), and there are also problems such as cytotoxicity and low releasing rate, and thus the overall antibacterial effect is limited. Furthermore, as for the organic antibacterial materials, a quaternary ammonium salt is commonly used as disinfectant and antibacterial agent of the fiber in the prior art, and also has the advantage of long-acting antibacterial effect. However, the quaternary ammonium salt has a poor thermal stability and cannot be used in a process of plastic or fiber spinning, thus having limitations in application.

Moreover, a new organic antibacterial material is developed recently, which is a halamine compound containing a functional group halamine N—X (in which X may be Cl, Br, or I). The functional group N—X in this type of compound will slowly disassociate in water with the action of water molecule in the presence of mircroorganisms, and release an oxidative halide ion, and the functional group N—X in this compound will be reduced into a functional group N—H. The released oxidative halide ion can kill mircroorganisms such as bacteria and mould, and the antibacterial effect is good and long acting. Furthermore, this type of halamine compound is quite stable, and doesn't tend to generate halogenated hydrocarbons, and has good biocompatibility. The halamine compound is generally used as textile additive, and used in post processing of a fiber by immersing or coating to fix the halamine compound onto the fiber, thereby enabling the fiber to obtain antibacterial efficacy. Generally, this type of halamine compound is required to be specially designed, to impart a special functional group thereto, such that the halamine compound can be covalently linked to the fiber. However, the manner above is not applicable for all fiber materials, and is not applicable for the high water-absorption γ-PGA fiber disclosed in U.S. application Ser. No. 12/757,288, either.

Therefore, it is necessary to develop an anti-bacterial fiber having high water absorptivity and biodegradability.

### SUMMARY

In one aspect, the present invention mainly provides a fiber having high water absorptivity and antibacterial property.

In order to achieve the above aspect of the present invention, the fiber having antibacterial property and high water absorptivity is a γ-PGA fiber. A main component of the γ-PGA fiber is a modified γ-PGA, and the modified γ-PGA is a polymer consisting of a γ-glutamic acid segment and a modified γ-glutamic acid segment, in which the modified γ-glutamic acid segment has a formula as shown below:

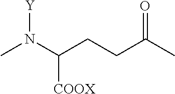

wherein X is H or Na, and Y is Cl, Br or I, and wherein a molar ratio of the modified γ-glutamic acid segment to the γ-glutamic acid segment is not lower than 0.05.

The high water-absorption and anti-bacterial fiber according to the present invention has good antibacterial property while maintaining good water absorptivity. Therefore, no microorganism contamination problem needs to be worried while applying these γ-PGA fibers.

These and other features, aspects, and advantages of the present invention will become better understood with reference to the following description and appended claims. It is to be understood that both the foregoing general description and the following detailed description are by examples, and are intended to provide further explanation of the invention as claimed.

### DETAILED DESCRIPTION

The high water-absorption fiber according to the present invention is a γ-PGA fiber. A main component of the γ-PGA fiber is a modified γ-PGA, and the modified γ-PGA is a polymer consisting of a γ-glutamic acid segment and a modified γ-glutamic acid segment, in which the modified γ-glutamic acid segment has a formula as shown in Formula (I) below:

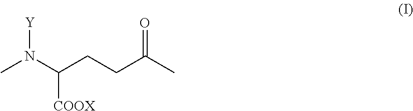

wherein X is H or Na, and Y is Cl, Br or I.

The modified γ-PGA above is a polymer formed by a γ-glutamic acid segment and a modified γ-glutamic acid segment. In the polymer, the arrangement of the γ-glutamic acid segment (referred to as “Segment A” hereinafter) and the modified γ-glutamic acid segment (referred to as “Segment B” hereinafter) is not particularly limited, and may be regular, partially regular, completely random, or a combination of two or more thereof. Specifically, in the modified γ-PGA of the present invention, when the arrangement of Segment A and Segment B is regular, examples may include, but are not limited to, ABABABAB, AABBAABB, AAABBAAABB, and the like; when the arrangement is partially regular, examples may include, but are not limited to, ABABAAABABB, AABBAABBABABABB, and the like; and when the arrangement is completely random, examples may include, but are not limited to, AABABBBAA, ABBBABABBA, and the like. It should be noted that the arrangements above will not influence the antibacterial function of the γ-PGA fiber according to the present invention.

The modified γ-PGA in the γ-PGA fiber of the present invention may be prepared in any available manners, and the preparation method is not particularly limited in the present invention. For example, the modified γ-PGA may be prepared by directly polymerizing Segment A and Segment B, or halogenating γ-PGA consisting of Segment A with a halogenating agent. In the second case, the γ-PGA consisting of Segment A may be formed by directly polymerizing Segment A, produced by mircroorganisms, isolated from natural products, or synthesized with a peptide synthesizer.

The above treatment with a halogenating agent is not particularly limited in the present invention, and may be, for example, partially oxidizing amino groups in Segment A with a halogenating agent by, for example, immersing or spraying.

The halogenating agent useful in the present invention may include, but is not limited to, perhalic acid, perhalates, halic acid, halates, halous acid, halites, hypohalous acid, hypohalites, halogen gases, trichloroisocyanuric acid (TCCA), or combinations thereof.

A preferred embodiment of the halogenating agent useful in the present invention includes, but is not limited to, sodium hypochlorite.

Moreover, the method for preparing the γ-PGA fiber above is not particularly limited in the present invention, and may be, for example, the method for preparing γ-PGA fiber as disclosed in U.S. application Ser. No. 12/757,288. In this case, the γ-PGA fibers having high water absorptivity are prepared by spinning out natural γ-PGA in a partially cross-linked form. However, the present invention is not limited thereto. Then, the obtained γ-PGA fibers are modified by treatment with one of the halogenating agents above, to obtain the high water-absorption γ-PGA fibers having antibacterial function as disclosed in the present invention.

Disclosure in U.S. application Ser. No. 12/757,288 is entirely incorporated herein by reference.

Furthermore, the modified γ-PGA may be directly spun out in a partially cross-linked form with reference to the method for preparing γ-PGA as disclosed in U.S. application Ser. No. 12/757,288.

In order to ensure a sufficient bactericidal capability of the γ-PGA fibers of the present invention, a molar ratio of the modified γ-glutamic acid segment to the γ-glutamic acid segment in the modified γ-PGA is preferably not smaller than 0.05, and is more preferably ½- 1/19.

The molecular weight of the modified γ-PGA useful in the present invention is not particularly limited and is preferably in the range of 500 to 2,000,000, and more preferably in the range of 1,000 to 2,000,000 in view of the is operation convenience.

As the conventional γ-PGA is easier to absorb water, a shaped body (e.g., fiber or fabric) is difficult to maintain its configuration. Therefore, the γ-PGA needs some modifications to increase strength thereof. A commonly used modification is carried out with a cross-linking agent, as described in the patents above. Though some modifier (e.g. cross-linking agent) is required to be added in preparation of the modified γ-PGA fiber, the main component of this modified γ-PGA fiber is still γ-PGA.

It should be understood by persons skilled in the art through this disclosure that the γ-PGA fibers may be processed to form a fabric by any available textile technology, such as a non-woven fabric. However, the present invention is not limited thereto. Furthermore, in order to impart other properties to the γ-PGA fibers or the fabrics thereof, a conventional fiber additive may be further added in the γ-PGA fibers or the fabrics thereof. Examples may include, but are not limited to, dyes, dyeing assistants, anti-UV agents, and matting agents, for example.

In the present invention, the disclosed high water-absorption γ-PGA fibers, having antibacterial function, achieve the antibacterial efficacy by the halamine functional group in the modified γ-glutamic acid thereof. The halamine functional group N—X (in which, X may be Cl, Br, or I) will interact with water molecules in the presence of microorganisms to release an oxidative halide ion in water. The halide ion can kill microorganisms such as bacteria and mould, and thus achieves the antibacterial efficacy.

Hereinafter, several embodiments are enumerated to further describe the method of the present invention in detail. However, these embodiments are provided only for exemplification and description, and not intended to limit the present invention, and the protection scope of the present invention is defined by the accompanying claims.

### EMBODIMENTS

### Preparation of γ-PGA Fiber

γ-PGA sodium salt (VEDAN Enterprise Corp, Taiwan) was formulated in water to give a solution of 6 wt %. Then, ethylene glycol diglycidyl ether (TOKYO YASEI, Japan), as a cross-linking agent, was added into the formulated γ-PGA solution at an amount of 7 μL cross-linking agent/g γ-PGA solution, relative to per 100 g γ-PGA solution. After adding the cross-linking agent, the initial viscosity of the γ-PGA solution before the reaction of cross-linking was 56.4 cp.

Then, the above γ-PGA solution was cross-linked at 60° C. with stirring at a rate of 50 rpm, till the viscosity rose to 82 cp (at about 240 min), and then the solution was passed through a spin nozzle for being spun out. In order to prevent the continuous cross-linking of the γ-PGA solution before passing through the spin nozzle, the temperature of the γ-PGA solution was dropped to 6° C. to slow down the cross-linking rate. Fibers obtained by passing through the spin nozzle were introduced into isopropyl alcohol (model TG-078-000000-75NL, Echo Chemical Co. Ltd, Taiwan) as a coagulation solution, so as to be shaped. Then, the prepared γ-PGA fibers were collected, transferred to an oven at 60° C., and dried for about 20 hours to obtain γ-PGA fibers.

### Preparation of Modified γ-PGA Fiber

### Embodiment 1

The γ-PGA fibers were immersed in 0.3 wt % sodium hypochlorite solution at a pH of 6-8 adjusted by 0.5 N phosphoric acid solution for 1 minute and then taken out. The fibers were rinsed with distilled water, put aside to be dried, and then detected with X-ray Energy Dispersive Spectrometer (EDS) for the increment ratio of chloride ions before and after immersing, to measure the content ratio of the modified γ-PGA segment to the unmodified γ-PGA segment.

### Embodiment 2

The γ-PGA fibers were immersed in 0.16 wt % sodium hypochlorite solution at a pH adjusted to 6-8 with 0.5 N phosphoric acid solution for 4 minutes, and then taken out. The fibers were rinsed with distilled water, put aside to be dried, and then detected with X-ray Energy Dispersive Spectrometer (EDS) for the increment ratio of chloride ions before and after immersing, to measure the content ratio of the modified γ-PGA segment to the unmodified γ-PGA segment.

### Embodiment 3

The γ-PGA fibers were immersed in 0.078 wt % sodium hypochlorite solution at a pH adjusted to 6-8 with 0.5 N phosphoric acid solution for 7 minutes, and then taken out. The fibers were rinsed with distilled water, put aside to be dried, and then detected with X-ray Energy Dispersive Spectrometer (EDS) for the increment ratio of chloride ions before and after immersing, to measure the content ratio of the modified γ-PGA segment to the unmodified γ-PGA segment.

### Embodiment 4

The γ-PGA fibers were immersed in 0.006 wt % sodium hypochlorite solution at a pH adjusted to 6-8 with 0.5 N phosphoric acid solution for 10 minutes, and then taken out. The fibers were rinsed with distilled water, put aside to be dried, and then detected with X-ray Energy Dispersive Spectrometer (EDS) for the increment ratio of chloride ions before and after immersing, to measure the content ratio of the modified γ-PGA segment to the unmodified γ-PGA segment.

### Comparative Example 1

The γ-PGA fibers were immersed in 0.005 wt % sodium hypochlorite solution at a pH adjusted to 6-8 with 0.5 N phosphoric acid solution for 10 minutes, and then taken out. The fibers were rinsed with distilled water, put aside to be dried, and then detected with X-ray Energy Dispersive Spectrometer (EDS) for the increment ratio of chloride ions before and after immersing, to measure the content ratio of the modified γ-PGA segment to the unmodified γ-PGA segment.

The content ratios of the modified γ-PGA segment to the unmodified γ-PGA segment in the embodiments and the comparative example are detailed in Table 1.

### Antibacterial Test

Antibacterial activity tests for most of the antibacterial agent are evaluated by combating against a broad spectrum of organisms including Gram positive organisms and Gram negative organisms. The test bacteria solutions in the present invention include Staphylococcus aureus (BCRC Number 15211) and Escherichia coli (BCRC Number 11446). Staphylococcus aureus is a Gram positive bacterium and Escherichia coli is a Gram negative bacterium.

### A. Culture of Bacteria Strain

A single colony of Staphylococcus aureus and that of Escherichia coli were picked up from a preserved agar medium respectively, then inoculated into a 15 mL centrifuge tube containing 2000 μL LB broth, and then shaken for 10 min, to fully disperse the cells. Next, 10-fold serial dilutions of the formed stock bacteria solution with LB broth were performed, to obtain diluted bacteria solutions having different dilution factors (10⁻¹, 10⁻², 10⁻³, 10⁻⁴ and 10⁻⁵). Then, 100 μL bacteria solutions of Staphylococcus aureus and Escherichia coli having different dilution factors were respectively inoculated onto different agar mediums and uniformly coated by a triangular glass rod. Subsequently, the agar mediums coated with bacteria solutions were placed and incubated for 14-24 hours in an incubator at 37° C. Then, the growth of the plated bacteria solutions having different dilution factors was observed, and the colony forming units (20-300 CFU) on agar were count. Through such a step, it was determined that the bacteria could normally grow in this environment or not. Then, according to a calculated CFUs of the agar medium, a suitable amount of stock bacteria solution was taken, and the content thereof was adjusted with sterilized water, to obtain a test solution having a concentration of 10⁶-10⁷ CFU/mL.

### B. Qualitative Antibacterial Test

100 μL test bacteria solutions (Staphylococcus aureus and Escherichia coli) having a concentration of 10⁶-10⁷ CFU/mL were respectively inoculated onto different agar mediums, and uniformly coated by a triangular glass rod. Then, samples prepared in Embodiments 1-4 and Comparative Example 1 were respectively cut into sheets, and the sheets covered on the agar mediums containing test bacteria solution above. Next, the agar mediums was placed and incubated for 14-24 hours in an incubator at 37° C. Then, the surfaces and surroundings of the samples were observed.

It was found through observation with naked eyes that no colony was formed on the surfaces and at surroundings of the samples of Embodiments 1-4, though the inhibition zone was unobvious, there was no colony formed on or below the sample. So it was concluded that they belong to the scope of contact inhibition, and thus would not release bacteria-inhibiting ingredient actively. In contrast, there were colonies formed on the surfaces and at surroundings of the sample of Comparative Example 1, and it could be seen that the surface and the surroundings of the sample were covered with colonies.

### C. Quantitative Antibacterial Test

This test is evaluation carried out according to static contact AATCC 100 antibacterial standard. Samples of Embodiments 1-4 and Comparative Example 1 were cut into a size of 2×2 cm², and respectively flatly attached on the bottom of 50 mL serum bottle. 20 μL original solutions of Staphylococcus aureus were inoculated on each sample, to respectively contact and culture the bacteria solution on the sample for 0 hour (contact for 0 hour means washing immediately) and 24 hours, and then the bacteria solutions were washed off with 20 mL Tween 80 solution, and respectively diluted by a factor of 10⁻¹, 10⁻², 10³, 10⁻⁴, and 10⁻⁵. 100 μL of the above 5 serial dilutions were each placed on different solid mediums and then uniformly coated onto agar. The plated agar was placed in an incubator at 37° C. After 14-24 hours of incubation, the growth of the bacteria solution washed off from the sample was observed, and colonies (20-300 CFU) on agar were counted and recorded.

Herein, the bactericidal capability of the sample is determined by the remaining colony number, and may be expressed by a formula below:

Bactericidal capability=(A−B)/A×100%,

A is colony number obtained by contacting 20 μL of original bacteria solution with a sample for 5 minutes, washing with 20 mL Tween 80, collecting the washed-off bacteria solution, plating, and incubating for 14-24 hours. B is colony number obtained by contacting 20 μL of original bacteria solution with a sample for 24 hours, washing with 20 mL Tween 80, collecting the washed-off bacteria solution, plating, and incubating for 14-24 hours.

When B is far greater than A, it is indicated that the sample has no antibacterial capability. The antibacterial results are as shown in Table 1.

TABLE 1
Results of quantitative antibacterial test

| | Ratio of | | | |
|---|---|---|---|---|
| | modified | | | |
| | segment to | Colony number (CFU/cm²) | | Bacteri- |
| | unmodified | 5 min | 24 hours | cidal |
| Sample Name | segment | (A) | (B) | rate (%) |
| Embodiment 1 | 1/2 | 3.11 × 10⁴ | 0 | >99.9 |
| Embodiment 2 | 1/5 | 4.05 × 10⁴ | 0 | >99.9 |
| Embodiment 3 | 1/10 | 5.87 × 10⁴ | 0 | >99.9 |
| Embodiment 4 | 1/19 | 5.24 × 10⁴ | 0 | >99.9 |
| Comparative | 1/25 | 5.45 × 10⁴ | >10⁶ | 0 |
| Example 1 | | | | |

It can be known from the results of the quantitative antibacterial test that, antibacterial effect can be observed with all samples of Embodiments 1-4, and only the sample of Comparative Example 1 has no antibacterial capability, so it can be concluded that the content ratio of the modified segment to the unmodified segment is preferably not lower than 1/19, which can enable the fiber to have a sufficient antibacterial efficacy.

It should be understood that the descriptions above are only preferred embodiments of the present invention, and not intended to limit the scope of the present invention, and equivalent changes or modifications made by any person skilled in the art without departing the spirits and scope of the present invention fall in the scope covered by the present invention.

What is claimed is:

1. A polyglutamic acid (γ-PGA) fiber having antibacterial property and water absorptivity, wherein a main component of the γ-PGA fiber is a modified γ-PGA, which is a polymer consisting of a γ-glutamic acid segment and a modified γ-glutamic acid segment, wherein the modified γ-glutamic acid segment has a formula as shown below: 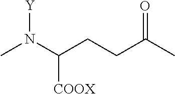
wherein X is H or Na, and Y is Cl, Br or I; and
wherein a molar ratio of the modified γ-glutamic acid segment to the γ-glutamic acid segment is not lower than 0.05.

2. The γ-PGA fiber of claim 1, wherein the molar ratio of the modified γ-glutamic acid segment to the γ-glutamic acid segment is 1:2-19.

3. A polyglutamic acid (γ-PGA) fabric having antibacterial property and water absorptivity, wherein the γ-PGA fabric is prepared with the γ-PGA fiber of claim 1.
